(19) United States
(12) Patent Application Publication
(10) Pub. No.: US 2025/0388799 A1
(43) Pub. Date: Dec. 25, 2025

(54) COOLANT COMPOSITION

(71) Applicant: TOYOTA JIDOSHA KABUSHIKI KAISHA, Toyota-shi, Aichi (JP)

(72) Inventor: Yasuaki KODAMA, Seto-shi (JP)

(73) Assignee: TOYOTA JIDOSHA KABUSHIKI KAISHA, Toyota-shi, Aichi (JP)

(21) Appl. No.: 19/202,213

(22) Filed: May 8, 2025

(30) Foreign Application Priority Data
Jun. 25, 2024 (JP) 2024-101909

(51) Int. Cl. C09K 5/20

(52) U.S. Cl. CPC C09K 5/20

(57) ABSTRACT

The present disclosure provides a coolant composition for an electric vehicle in which fluoride ions are sufficiently removed. The present disclosure relates to a coolant composition for an electric vehicle that contains a fluorine remover including calcium carbonate, calcium nitrate, or a mixture thereof. The coolant composition has a fluoride ion content of 80 ppm or less, a pH of 6 to 9, and an electric conductivity of 250 μS/cm or less.

### CROSS REFERENCE TO RELATED APPLICATIONS

The present application claims priority from Japanese patent application JP 2024-101909 filed on Jun. 25, 2024, the entire content of which is hereby incorporated by reference into this application.

### BACKGROUND

### Technical Field

The present disclosure relates to a coolant composition for an electric vehicle.

### Background Art

In an electric vehicle, a coolant is used to cool a battery or the like. The coolant may contain components of materials used in the manufacture of the cooling system components. For example, a residue of flux used for brazing in a manufacturing process of an aluminum heat exchanger, which is used for a battery cooler or the like, may be dissolved in the coolant, causing fluoride ions (also referred to as fluorine ions) in the flux to be mixed into the coolant. Fluoride ions are metal-corrosive ions, and there is a concern that the metal in the cooling system may rust. In addition, when the coolant has pH on the alkaline side, there is also a concern that the metal in the cooling system may rust.

A battery for a battery electric vehicle (BEV), a plug-in hybrid electric vehicle (PHEV), or the like is required to have high electrical resistance. When such a component requiring high electrical resistance is cooled, it is preferable to apply a coolant having a low electric conductivity. However, a typical engine coolant has high electric conductivity. In addition, a rust inhibitor is usually added to the coolant. When the amount of the rust inhibitor added is reduced to lower the electric conductivity of the coolant, the rust-inhibiting ability of the coolant is reduced.

Thus, the coolant for an electric vehicle is required to have a high anticorrosion property and low conductivity. Regarding the high anticorrosion property, the coolant is required to have a sufficiently low content of fluoride ions, which are metal-corrosive ions, and to have a neutral pH.

Here, as a technique for removing fluorine in wastewater, techniques using a calcium compound such as calcium nitrate, calcium hydroxide, or calcium carbonate have been known (JP 2006-212471 A, JP 2005-342698 A, and JP 2000-246267 A). However, in the fluorine removal for the purpose of wastewater treatment as disclosed in JP 2006-212471 A, JP 2005-342698 A, and JP 2000-246267 A, an efficiency of fluorine removal and reuse has been pursued. In view of this, even when the conventional fluorine removal technique is applied to the coolant, properties required for the coolant for an electric vehicle cannot be satisfied.

### SUMMARY

As described above, even when the conventional fluorine removal technique is applied to the coolant, the properties required for the coolant for an electric vehicle cannot be satisfied. Therefore, the present disclosure provides a coolant composition for an electric vehicle in which fluoride ions are sufficiently removed.

The present inventor has found that adding calcium carbonate, calcium nitrate, or a mixture thereof as a fluorine remover can maintain a neutral pH and low electric conductivity while sufficiently removing fluoride ions in the coolant composition, and have completed the present disclosure.

That is, the gist of the present disclosure is as follows.
(1) A coolant composition for an electric vehicle comprises a fluorine remover including calcium carbonate, calcium nitrate, or a mixture thereof. The coolant composition has a fluoride ion content of 80 ppm or less, a pH of 6 to 9, and an electric conductivity of 250 μS/cm or less.
(2) In the coolant composition for an electric vehicle according to (1), a content of the calcium carbonate is 3 g/L to 50 g/L based on components other than the fluorine remover in the coolant composition, and a content of the calcium nitrate is 3 g/L to 60 g/L based on the components other than the fluorine remover in the coolant composition.
(3) In the coolant composition for an electric vehicle according to (1) or (2), the fluorine remover comprises the calcium carbonate or the calcium nitrate.
(4) The coolant composition for an electric vehicle according to any of (1) to (3) further comprises a base. The base is at least one alcohol selected from the group consisting of a dihydric alcohol, a trihydric alcohol, and a glycol monoalkyl ether, and/or water.
(5) In a concentrated coolant composition for obtaining the coolant composition for an electric vehicle according to any of (1) to (4), the concentrated coolant composition is used after being diluted with water.
The present disclosure can provide a coolant composition for an electric vehicle in which fluoride ions are sufficiently removed.

### DETAILED DESCRIPTION

The following describes embodiments of the present disclosure in detail.

A coolant composition for an electric vehicle (hereinafter, also referred to as a coolant composition) of the present disclosure contains a fluorine remover including calcium carbonate, calcium nitrate, or a mixture thereof. The coolant composition of the present disclosure has properties required for a coolant composition for an electric vehicle by containing the fluorine remover. Specifically, the coolant composition of the present disclosure has a fluoride ion content of 80 ppm or less, a pH of 6 to 9, and an electric conductivity of 250 μS/cm or less.

In the coolant composition of the present disclosure, calcium carbonate, calcium nitrate, or a mixture thereof is used as a fluorine remover. In one embodiment, the fluorine remover includes calcium carbonate or calcium nitrate.

In the coolant composition of the present disclosure, a content of the fluorine remover can be appropriately set according to the properties required for the coolant composition.

In the coolant composition of the present disclosure, a content of calcium carbonate may be 3 g/L to 50 g/L based on components other than the fluorine remover in the coolant composition. When the content of calcium carbonate is 3 g/L or more, fluoride ions are sufficiently removed from the coolant composition. Therefore, an anticorrosion property of the coolant composition is improved. When the content of calcium carbonate is 50 g/L or less, an increase in pH of the coolant composition is suppressed. Therefore, the anticorrosion property of the coolant composition is improved.

In the coolant composition of the present disclosure, a content of calcium nitrate may be 3 g/L to 60 g/L based on the components other than the fluorine remover in the coolant composition. When the content of calcium nitrate is 3 g/L or more, fluoride ions are sufficiently removed from the coolant composition. Therefore, the anticorrosion property of the coolant composition is improved. When the content of calcium nitrate is 60 g/L or less, an increase in electric conductivity of the coolant composition is suppressed.

In one embodiment, the fluorine remover is a mixture of calcium carbonate and calcium nitrate. Also in this embodiment, the content of the fluorine remover can be appropriately set according to the properties required for the coolant composition. In this embodiment, for example, the content of calcium carbonate may be 3 g/L to 50 g/L based on the components other than the fluorine remover in the coolant composition, and the content of calcium nitrate may be 3 g/L to 60 g/L based on the components other than the fluorine remover in the coolant composition. In another embodiment, the content of calcium carbonate may be 10 g/L to 30 g/L based on the components other than the fluorine remover in the coolant composition, and the content of calcium nitrate may be 10 g/L to 35 g/L based on the components other than the fluorine remover in the coolant composition.

When the fluorine remover is the mixture of calcium carbonate and calcium nitrate, a mass ratio of calcium carbonate to calcium nitrate is usually 1:100 to 100:1, and may be 1:10 to 10:1.

The coolant composition of the present disclosure may contain a base. The content of the base is usually 1% by mass to 95% by mass, and may be 25% by mass to 60% by mass, based on the coolant composition.

As the base, for example, at least one alcohol selected from the group consisting of dihydric alcohols, trihydric alcohols, and glycol monoalkyl ethers, and/or water can be used.

Examples of dihydric alcohol may include ethylene glycol, diethylene glycol, triethylene glycol, propylene glycol, 1,3-propanediol, 1,4-butanediol, 1,3-butanediol, 1,5-pentanediol, and hexylene glycol.

Examples of trihydric alcohol may include glycerin, trimethylolethane, trimethylolpropane, 5-methyl-1,2,4-heptanetriol, and 1,2,6-hexanetriol.

Examples of glycol monoalkyl ether may include ethylene glycol monomethyl ether, diethylene glycol monomethyl ether, triethylene glycol monomethyl ether, tetraethylene glycol monomethyl ether, ethylene glycol monoethyl ether, diethylene glycol monoethyl ether, triethylene glycol monoethyl ether, tetraethylene glycol monoethyl ether, ethylene glycol monobutyl ether, diethylene glycol monobutyl ether, triethylene glycol monobutyl ether, and tetraethylene glycol monobutyl ether.

In one embodiment, the alcohols are ethylene glycol, propylene glycol, and 1,3-propanediol from the aspect of handleability, cost, and availability.

The base may be a mixture of water and alcohols. When the mixture of water and alcohols is used as the base, a ratio of water to alcohols in the base is usually 20:80 to 90:10, and may be 40:60 to 75:25, from the aspect of avoiding an occurrence of a flash point.

When an antifreeze property is not required, the base may be water alone.

In one embodiment, the base is a mixture of dihydric alcohol and water, and may be a mixture of ethylene glycol and water.

In addition to the above base or fluorine remover, the coolant composition of the present disclosure may contain, as necessary, one or more further additives as long as the effects of the present disclosure are not impaired. The further additives are not particularly limited, and examples thereof include rust inhibitors (carboxylic acids, nitrates, nitrites, thiazoles, molybdates, borates, and the like), dye, bittering agents, pH regulators, and antifoaming agents. The total content of the further additives is usually 10% by mass or less, and may be 5% by mass or less, based on the coolant composition.

The coolant composition of the present disclosure has a sufficiently low content of fluoride ions, and it is 80 ppm or less. The coolant composition of the present disclosure has an excellent anticorrosion property since the content of fluoride ions, which are metal-corrosive ions, is sufficiently low.

The coolant composition of the present disclosure has a pH of 6 to 9 (that is, 6.0 or more and 9.0 or less). When the coolant composition has the pH of 6 to 9, the coolant composition has an excellent anticorrosion property.

The coolant composition of the present disclosure has sufficiently low conductivity, and has electric conductivity of 250 μS/cm or less at 25° C. The electric conductivity of the coolant composition can be measured as described in Examples.

A method for producing the coolant composition of the present disclosure is not particularly limited, and a common producing method can be used. For example, the coolant composition of the present disclosure can be produced by preparing a mixture containing the above base, and as necessary, the further additives, adding a fluorine remover to the mixture, and uniformly stirring the mixture. The coolant composition of the present disclosure can also be produced by mixing the above base, the fluorine remover, and as necessary, the further additives, and uniformly stirring the mixture.

The present disclosure also includes a concentrated coolant composition for obtaining the above coolant composition. The concentrated coolant composition of the present disclosure contains the above base and fluorine remover, and, as necessary, contains further additives. The concentrated coolant composition of the present disclosure can be used by being diluted, for example, 1.1-fold by mass to 5-fold by mass with water. The concentrated coolant composition of the present disclosure need not contain water, or may contain water. When the concentrated coolant composition of the present disclosure contains water, the content thereof is smaller than the water content in the coolant composition.

The coolant composition of the present disclosure has an excellent anticorrosion property since fluoride ions are sufficiently removed and the pH is neutral. The coolant composition of the present disclosure has low conductivity. Therefore, the coolant composition of the present disclosure is appropriately used as a coolant composition for an electric vehicle. An electric vehicle to which the coolant composition of the present disclosure can be applied may be a vehicle including a traction motor, and examples thereof include a battery electric vehicle (BEV), a hybrid electric vehicle (HEV), and a plug-in hybrid electric vehicle (PHEV). The coolant composition of the present disclosure can be used to cool heat generation equipment (for example, a battery, an inverter, a radiator, an oil cooler, a heater core, and the like) for an electric vehicle.

### EXAMPLES

The following describes the present disclosure more specifically using Examples. However, the technical scope of the present disclosure is not limited to these Examples.

### Preparation of Coolant Composition

Calcium carbonate or calcium nitrate (fluorine remover) was added to a commercially available coolant (traction battery coolant manufactured by Toyota Motor Corporation) containing ethylene glycol and water as a base in amounts shown in Table 1, and each coolant composition of Examples 1 to 4 and Comparative Examples 1 to 4 was prepared. The content (g/L) of the fluorine remover is an amount based on components other than the fluorine remover in the coolant composition (that is, the commercially available coolant used).

### Evaluation of Coolant Composition

For the coolant compositions of Examples 1 to 4 and Comparative Examples 1 to 4, a fluoride ion content, pH, and electric conductivity were measured as follows.

### Fluoride Ion Content

The fluoride ion content was measured by a flask combustion method with an ion chromatograph manufactured by Shimadzu Corporation. The fluoride ion content is based on mass (ppm by mass).

pH

The pH was measured at 25° C. with a pH meter (PH71 Personal pH Meter manufactured by Yokogawa Electric Corporation).

### Electric Conductivity

The electric conductivity was measured at 25° C. with an electric conductivity meter (SC72 Personal Handheld Conductivity Meter and a sensor SC72SN-11 (for pure water) manufactured by Yokogawa Electric Corporation).

For the coolant compositions of Examples 1 to 4 and Comparative Examples 1 to 4, the type and content of the fluorine remover, and the evaluation results are shown in Table 1.

TABLE 1

| | | Examples | | | | Comparative Examples | | | |
|---|---|---|---|---|---|---|---|---|---|
| | | 1 | 2 | 3 | 4 | 1 | 2 | 3 | 4 |
| Fluorine Remover [g/L] | Calcium Carbonate | 3 | 50 | | | 2 | 60 | | |
| | Calcium Nitrate | | | 3 | 60 | | | 2 | 70 |

| | | | | | | | | |
|---|---|---|---|---|---|---|---|---|
| Fluoride Ion [ppm] | 79 | 34 | 80 | 30 | 100 | 28 | 101 | 28 |
| pH | 7.6 | 9 | 7.3 | 6.4 | 7.5 | 9.1 | 7.4 | 6.1 |
| Electric Conductivity [μS/cm] | 102 | 220 | 103 | 250 | 101 | 200 | 101 | 272 |

As shown in Table 1, when the fluorine remover was calcium carbonate (Examples 1 and 2 and Comparative Examples 1 and 2), the pH of the coolant composition increased as the content of calcium carbonate increased. This is considered to be because a carbon dioxide gas produced by dissolution of calcium carbonate was discharged out of the liquid, and only a calcium content remained in the liquid.

As shown in Table 1, when the fluorine remover was calcium nitrate (Examples 3 and 4 and Comparative Examples 3 and 4), the electric conductivity of the coolant composition increased as the content of calcium nitrate increased. This is considered to be because, unlike carbonate ions that produced the carbon dioxide gas, nitrate ions are present in the liquid as ions and increase the electric conductivity.

All publications, patents, and patent applications cited herein are incorporated herein by reference in their entirety.

What is claimed is:

1. A coolant composition for an electric vehicle, comprising
a fluorine remover comprising calcium carbonate, calcium nitrate, or a mixture thereof,
wherein the coolant composition has:
a fluoride ion content of 80 ppm or less;
a pH of 6 to 9; and
an electric conductivity of 250 μS/cm or less.

2. The coolant composition for an electric vehicle according to claim 1,
wherein a content of the calcium carbonate is 3 g/L to 50 g/L based on components other than the fluorine remover in the coolant composition, and
wherein a content of the calcium nitrate is 3 g/L to 60 g/L based on the components other than the fluorine remover in the coolant composition.

3. The coolant composition for an electric vehicle according to claim 1,
wherein the fluorine remover comprises the calcium carbonate or the calcium nitrate.

4. The coolant composition for an electric vehicle according to claim 1, further comprising
a base,
wherein the base is at least one alcohol selected from the group consisting of a dihydric alcohol, a trihydric alcohol, and a glycol monoalkyl ether, and/or water.

5. A concentrated coolant composition for obtaining the coolant composition for an electric vehicle according to claim 1,
wherein the concentrated coolant composition is used after being diluted with water.
